(19) United States
(12) Patent Application Publication
(10) Pub. No.: US 2010/0210320 A1
(43) Pub. Date: Aug. 19, 2010

(54) SELF-CHARGING ULTRA LOW COST MOBILE HANDSET

(76) Inventor: Nigel Waller, London (GB)

Correspondence Address: STEPTOE & JOHNSON LLP, 1330 CONNECTICUT AVENUE, N.W., WASHINGTON, DC, 20036, US

(21) Appl. No.: 12/371,671

(22) Filed: Feb. 16, 2009

(51) Int. Cl. H04M 1/00

(52) U.S. Cl. 455/573

(57) ABSTRACT

Disclosed is a self-charging mobile handset. Access to mobile phones plays a key part in poverty reduction; however there are over 1.6 billion people who do not have direct access to electricity to charge mobile phones in Sub-Sahara Africa and South Asia. People in these countries may spend up to 6 hours a week walking to other villages to charge phones, or will pay local businessmen offering charging services to connect their phones to chargers connected to car batteries. By installing a easy to use squeeze type dynamo into the housing, a phone can be manufactured which is both self charging and low cost.

### US PATENT DOCUMENTS REFERENCED

U.S. Pat. No. 7,289,831 B2, Endless Powered Anywhere Cellphone System, Trozzi, Issued Oct. 30, 2007

US 2004/0204180 A1, Cellular Phone with Built-in Generator, Liao, Application Published Oct. 14, 2004

US 2007/0080814 A1, Dynamo Operated Portable Device Having an Alert Radio, Ellsworth et al., Assignee Vector Products Inc., Application Published Apr. 12, 2007

US2007/0024233 A1, Armature Type Electrical Generators for Self Powered Cell Phones, Ekchian et al., Application Published Feb. 1, 2007

US 2007/0177377 A1, Rechargeable Flashlight, Ding et al., Application Published Aug. 2, 2007

### STATEMENT REGARDING FEDERALLY SPONSORED RESEARCH OR DEVELOPMENT

Not Applicable.

### BACKGROUND OF THE INVENTION

The present invention relates generally to telephony communications; and more specifically to an ultra low cost handset which is self-charging.

Access to mobile phones plays a key part in poverty reduction; however mobile phones however consume power when operational. A typical phone may last 3 or 4 days on standby, or even less than a day if it is heavily used. The phone then has to be connected to a charger which is typically plugged into an electricity socket, to enable the rechargeable battery located inside the phone handset housing to be recharged, to enable the phone to be used again.

According to the World Bank, there are over 1.6 billion people who do not have direct access to electricity to charge mobile phones in Sub-Sahara Africa and South Asia. Those people who are able to afford a phone handset may spend up to 6 hours a week walking to other villages to find electricity to charge phones, or they may pay local businessmen offering charging services to connect their phones to chargers connected to car batteries.

By implementing a low cost, and easy to use method, to charge a phone and by incorporating this into the handset housing itself, we can save the time spent by these people walking to villages to charge their handsets, or the money they spend on charging services. By saving money, we are helping these people get out of poverty.

A number of methods have been previously described in prior art to self-charge a mobile handset. There are a number of patents that describe the addition of a solar array to a mobile phone, however these types of arrays are typically very expensive, and are too expensive for poor communities where the phone handset itself may only cost $20-$30. U.S. Pat. No. 7,289,831 by Trozzi incorporates a hand crack dynamo into a handset housing, however it is believed that such an attachment onto a phone would be cumbersome to use. In U.S. patent application Ser. No. 11/191,890 Ekchian et al have incorporated a dynamo into a handset housing with no external parts, however it is felt that this method would be too expensive to produce for a low cost handset.

Ding et al., in US Patent Application US2007/0177377 have incorporated a hand press dynamo into a flashlight. The specifications of these types of small dynamos has increased considerably to enable such a dynamo to be connected to a low powered mobile phone circuit.

### BRIEF SUMMARY OF THE INVENTION

The self-powered handset disclosed herein is an innovative concept which is both low cost and easy to use. By building a hand press dynamo into a low powered mobile handset housing, we can achieve both a low cost of manufacture and an easy to use phone charging system whereby the user would squeeze the hand press arm 3 or 4 times to enable the phone to charge to last for a few hours. In the poor communities in Sub-Sahara Africa and South Asia, people on average will make calls lasting at most two minutes, and will only call 10-15 times a month. This typical low usage is therefore matched very well to the type of self-charging described in this invention.

The above examples illustrate the use of a self-powered handset to make and receive a call, but the same handset could also be used to send and receive data, such as SMS messages or email. For example it is possible that the handset could be used as a remote data logger which is only required to be powered up and activated when it is required to download data using a wireless connection.

Although the method disclosed, by and large employs a series of general purpose components to achieve its ends, the bona fide distinctiveness of the invention resides in the combination of a hand press dynamo with a low powered mobile phone handset.

### BRIEF DESCRIPTION OF THE DRAWINGS

The foregoing summary of the invention, as well as the following detailed description of the preferred embodiment, is better understood when read in conjunction with the accompanying drawings, which are included by way of example, and not by way of limitation with regard to the claimed invention:

FIG. 1. is a front view of an exemplary handset with self charging handle in accordance with the present invention; and

FIG. 2. is a rear internal view of an exemplary handset depicting the internal mechanism according to one embodiment of the present invention.

FIG. 3. Is a block diagram of the components functions of an exemplary handset incorporating the dynamo in accordance with the present invention.

### DETAILED DESCRIPTION OF THE PRESENTLY PREFERRED EMBODIMENT

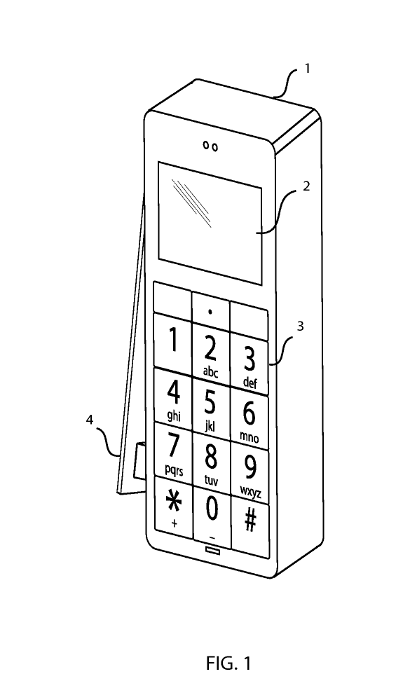

FIG. 1. Depicts an exemplary handset for use in a wireless telecommunications network which can be used for making and receiving voice calls and data. The operation of the handset in general will be described followed by a description of how the self-charging mechanism is implemented.

In FIG. 1. The mobile handset housing 1 has cut aways to house an input keypad 3, a display 2 and a microphone and speaker. At the side of the handset is an arm 4, shown here in a released position, which when squeezed will charge the battery inside the handset.

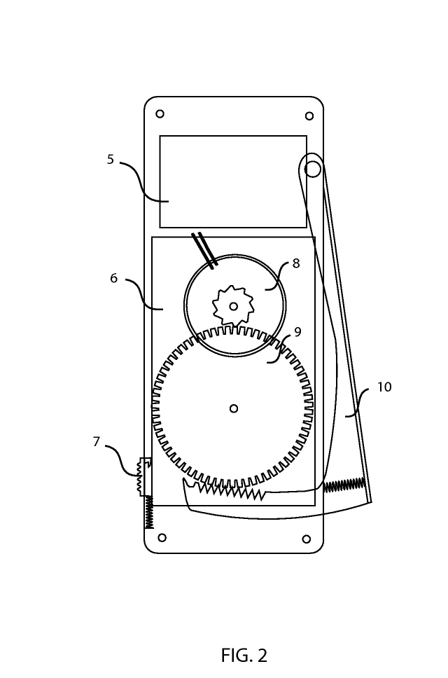

FIG. 2 shows a rear internal view of an exemplary handset in the preferred embodiment. When the arm 10 is squeezed by a hand holding the handset, gear 9 turns which in turn spins the dynamo 8. Once released the handle returns to its original position by virtue of a spring located in the handle. The arm can then be squeezed two or three more times in quick succession to enable the dynamo 8 to reach its normal operating speed of 1000-3000 rpm.

The dynamo 8 uses rotating coils of wire and magnetic fields to convert mechanical rotation into a pulsing direct electric current through Faraday's law. At its normal operating speed, the dynamo will produce 5.0 V DC and will be connected to a charging circuit by a series of wires. A battery 6, which can be a Ni-MH, Nickel Cadmium or Lithium rechargeable battery is connected to the charging circuit. The charging circuit is equipped with diodes to protect the battery 6 from power spikes caused by the dynamo 8.

In the preferred embodiment, the battery 6 is located between the dynamo 8 and the main PCB housing the baseband signal processor, memory, power amplifier and RF components. In this manner the battery acts as an magnetic shield to protect the RF and other components from magnetic and flux fields caused by the dynamo. The handset is design for low cost and therefore the battery 6 can be glued into place rather than add unnecessary parts to enable the battery to be removed and changed.

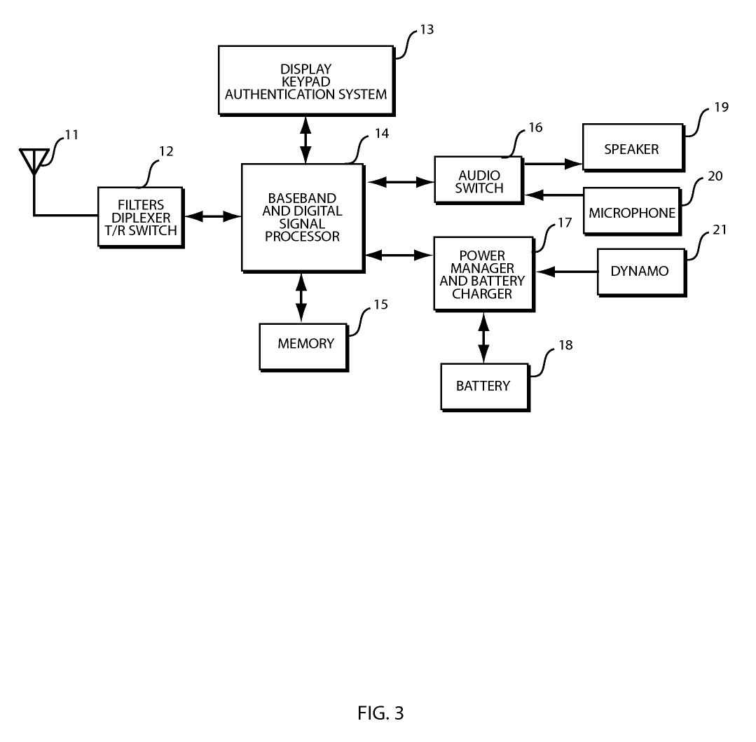

FIG. 3 shows a block diagram of the component functions of the handset in the preferred embodiment. The dynamo 21 charges the battery 18 through the power management and battery charger 17. The battery 18 powers the circuitry in the mobile handset. The circuitry includes an antenna 11 connected to a series of filters and a Transmit/Receive switch 12 which in turn is connected to a core baseband and signal processing chip 14. The user interacts with the processor by means of the display and keyboard 13. An authentication system 13 is located in the handset, in the case of a GSM handset this will include a Subscriber Identity Module (SIM card). A speaker 19 and a microphone 20 are connected to the baseband and signal processing chip by virtue of an audio switch 16 to enable the user to speak and hear voice conversations during a call over the mobile network.

While the foregoing describes what are considered to be the preferred embodiments of the invention, it is understood that various modifications may be made therein and that the invention may be implemented in various forms and alternate embodiments, and indeed that it may be applied in numerous applications, only some of which have been described. The claims are intended to cover all such modifications and variations which fall within the true scope of the invention.

The invention claimed is:

1. A handset for use in a mobile network comprising a housing, an input device, a processor, a radio transmitter and receiver, a network authentication system, a battery, a charging circuit, a dynamo electric generator, a plurality of gears connected to the dynamo and a squeeze handle connected to the plurality of gears wherein squeezing the handle charges the battery.

2. A handset as claimed in claim 1, wherein the handset makes and receives voice calls.

3. A handset as claimed in claim 1, wherein the handset receives non-voice data transmission.

4. A handset as claimed in claim 1, wherein the handset sends non-voice data transmission.

5. A handset as claimed in claim 1, wherein the dynamo, plurality of gears and squeeze handle are located in a separate housing from the handset, connected by a power cable.
